(19) United States
(12) Patent Application Publication
(10) Pub. No.: US 2017/0336895 A1
(43) Pub. Date: Nov. 23, 2017

(54) Touch Sensor Regulator Device and Method

(71) Applicant: A D Metro, Ontario (CA)

(72) Inventor: Albert M. David, Ontario (CA)

(21) Appl. No.: 15/159,865

(22) Filed: May 20, 2016

(51) Int. Cl. G06F 3/045

(52) U.S. Cl. CPC G06F 3/045

(57) ABSTRACT

Resistive touch sensors, such as those used in touchscreen panels, typically comprise multiple sheets separated by a gap. Typically, one sheet is a hard substrate layer, and the other sheet is a flexible switch layer that, when touched, flexes to touch the substrate layer. Changes in pressure within the gap may damage a resistive touch sensor. According to an aspect, there is provided a touch sensor device comprising a first sheet having and a second sheet overlaying and being spaced from the first sheet, thereby forming a gap. The gap is filled with gas, typically air, and has a sealed periphery. The touch sensor also includes a hole in the first sheet extending from the gap to an outer surface of the first sheet. The touch sensor device also includes a regulator device attached to the hole to allow flow of the gas between the chamber and the gap.

### FIELD OF THE DISCLOSURE

Aspects of the disclosure relate to touch sensor devices. More particularly, aspects of the disclosure relate to resistive touch sensor devices comprising first and second sheets separated by a gap,

### BACKGROUND

Of various interfaces available for interacting with a computer system, one of the easiest to use and understand is the touchscreen. This technology allows a user to simply touch an icon or picture to navigate through the system, display the information the user is seeking, and to enter data. For this reason, this technology is widely used in many applications, including desktop computers, tablet computers, mobile devices, bank machines, information kiosks, restaurants, cars, navigation systems, etc.

A number of different conventional touchscreen technologies exist. These methodologies include resistive, capacitive, surface acoustic wave, infrared, and optical touchscreen technology.

Resistive touch sensors, such as those used in touchscreen panels, typically comprise multiple sheets separated by a gap. Typically, one sheet is a hard substrate layer, and the other sheet is a flexible switch layer that, when touched, flexes to touch the substrate layer. Each sheet typically has a surface coated with a conductive layer. The sheets may be substantially transparent. A typical transparent substrate is glass. The conductive layers may be an Indium Tin Oxide (ITO) coating. Alternatively, a fine conductive mesh (such as a metal mesh) or other conductive material may be used for the conductive layer of one or more sheets.

Sensors, typically located at the corners of the touch sensor, may detect differences in voltage or current measured at the sensors that occur when the sensor is touched. The differences in voltage or current will depend on the location of contact of the sheets caused by the touch. Thus, by analyzing the measurements from the sensors, the position of the touch may be computed.

The gap between the conductive layers of the sheets is typically filled with air. Conventional sensors may include “spacer dots” or “microdots” between the substrate and sensor layers to help maintain the gap and separation. The gap may have a periphery or outer perimeter around sides of the sensor (i.e. near side edges of the two sheets) that is sealed to prevent moisture, dust or other contaminants from entering the gap and damaging the sensor or degrading sensor performance. The seal may be a gasket that extends around the outer perimeter of the surfaces of the sheets that face each other.

A conventional sensor may be hermetically sealed. For example, a periphery of the gap may be sealed. The air in the gap may expand and/or contract due to temperature and pressure changes in the touch sensor's environment. The expansion and/or contraction of the air in the gap can cause damage to the sensor. For example, if the air expands too much, the seal for the gap (e.g. a gasket) may rupture and air may escape. Then, if the air contracts, the touch sensor may collapse such that the conductive layers of the sensor sheets are no longer properly separated, In some touchscreen panels, a pressure change in of approximately 100 mbar could be sufficient to cause damage. The chance of sensor failure may be exacerbated if the touch sensor device is not mounted properly in a housing. A gasket or housing for the sensor may not be mounted properly, thereby lowering the temperature or pressure change that could damage the sensor.

A touch sensor with an unsealed or vented gap area may allow air pressure to equalize with the surrounding environment to reduce the chance of failure due to temperature/pressure changes. However, the unsealed or vented sensor may be prone to failure due to contaminants such as dust entering the gap and interfering with the contact between the sheets as well as creating optical deficiencies from such contaminants. Moisture from condensation or cleaning agents can be wicked in through the vent as well which may cause electrical shorting between the conductive layer which can cause erratic operation or a constant touch event. Also, the air gap can also become blocked by mounting such as squeezing it shut by a front foam or rubber gasket needed to seal the sensor in the bezel or housing of the equipment unless special precautions are taken to prevent that from happening.

### SUMMARY

According to one aspect of the disclosure, there is provided a touch sensor device comprising: a first sheet having a first conductive layer; a second sheet having a second conductive layer overlaying and spaced from the first conductive layer of the first sheet, thereby forming a gap between the first and second sheets, the gap being filled with gas and having a sealed periphery; a hole in the first sheet extending from the gap to an outer surface of the first sheet; and a regulator device comprising an expandable and contractible chamber, the regulator device being connected to the hole to allow flow of the gas between the chamber and the gap.

In some embodiments, the touch sensor device further comprises a conduit connecting the regulator device is connected to the hole allowing said flow of the gas.

In some embodiments, the chamber expands and contracts to regulate pressure of the gas in the gap.

In some embodiments, the chamber comprises a flexible diaphragm that provides said expansion and contraction.

In some embodiments, the diaphragm comprises an elastomeric film.

In some embodiments, the elastomeric film comprises latex.

In some embodiments, the hole extends through the first conductive layer and to the outer surface.

In some embodiments, the outer surface of the first sheet is a side surface between the first surface and a back surface opposite to the first surface.

In some embodiments, the outer surface of the first sheet comprises a back surface opposite to the first surface.

In some embodiments, the first sheet comprises a substrate sheet and the first sheet comprises a switch sheet,

In some embodiments, the second sheet is flexible to contact the first sheet when touched.

In some embodiments, the substrate sheet and the switch sheet are each substantially transparent.

In some embodiments, each of the first and second sheets comprise a conductive coating.

In some embodiments, the device is hermetically sealed.

In some embodiments, the gas comprises air,

According to another aspect of the disclosure, there is provided a method for a resistive touch sensor comprising a first sheet overlaying and spaced from a second sheet to form a gap therebetween filled with gas, the method comprising: providing a hole in the first sheet from the gap to an outer surface of the first sheet; connecting a regulator device comprising an expandable and contractible chamber to the hole to allow flow of the gas between the chamber and the gap.

In some embodiments, said connecting comprises connecting a tube between the hole and the regulator device.

According to another aspect of the disclosure, there is provided a regulator device for a touch sensor comprising a first sheet overlaying and spaced from a second sheet to form a gap therebetween filled with gas, the regulator device comprising: an expandable and contractible chamber; a conduit for connecting the regulator device to a hole in the touch sensor to allow flow of the gas between the chamber and the gap.

In some embodiments, the conduit comprises a tube.

In some embodiments, the chamber expands and contracts to relieve regulate at least one of pressure and volume of the gas in the gap.

Other aspects and features of the present disclosure will become apparent, to those ordinarily skilled in the art, upon review of the following description of the specific embodiments of the disclosure.

### BRIEF DESCRIPTION OF THE DRAWINGS

Some embodiments of the disclosure will now be described in greater detail with reference to the accompanying diagrams, in which:

FIG. 1 is an exploded perspective view of an example resistive touch sensor;

FIG. 2 is side cross-sectional view of another touch sensor;

FIG. 3 is side cross-sectional view the touch sensor of FIG. 2;

FIG. 4 is side cross-sectional view the touch sensor of FIGS. 2 and 3;

FIG. 5 is side cross-sectional view of a touch sensor device according to one embodiment;

FIG. 6 is side cross-sectional view the touch sensor device of FIG. 5;

FIG. 7 is side cross-sectional view the touch sensor device of FIGS. 5 and 6;

FIG. 8 is a perspective view of the touch sensor device of FIGS. 5 to 7;

FIG. 9 is a side cross-sectional view a touch sensor device according to another embodiment; and

FIG. 10 is a flowchart of a method according to another embodiment.

### DETAILED DESCRIPTION

As discussed above, conventional touch sensor devices having a gap between sheets of the sensor (such as resistive sensors) may fail due to temperature and/or pressure changes that cause expansion or contraction of the air or other gas in the gap. It may be desirable to provide a sealed sensor that includes means for regulating the pressure and/or volume of the air or other gas within the gap between sheets. The term “gas” is used broadly herein to include both a pure gas and a gas mixture, such as air. Embodiments are not limited to any particular gas content within the gap of a resistive sensor.

It is to be understood that references herein to orientations such as “front”, “back”, “side”, “upper”, “lower” etc. or to directions are for ease of description and are not intended to limit the orientation of the embodiments described herein and shown in the figures.

It will be appreciated by a person skilled in the art that various elements of the embodiments shown in the figures are not necessarily shown to scale. For example some elements may be shown enlarged in comparison to other elements for illustrative purposes. The figures are not intended to limit any embodiments to a particular relative sizing of elements.

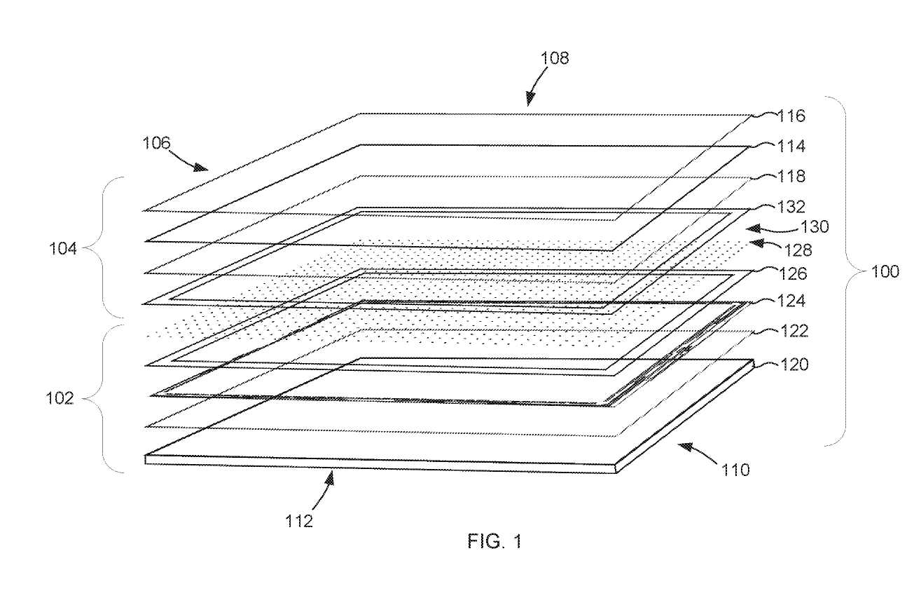

FIG. 1 is an exploded perspective view of an example resistive touch sensor 100 for a touchscreen device. The touch sensor 100 includes a switch layer 104 and a substrate layer 102 that are each generally flat and rectangular. The switch layer 104 and a substrate layer 102 have similar sizes (length and width). The touch sensor 100 has four sides 106, 108, 110 and 112. The switch layer 104 overlays the substrate layer 102. The switch layer 104 in this example includes a Polyethylene Terephthalate (PET) anti-newton ring film or sheet 114 that has an acrylic hard coat 106 facing away from the touch sensor 100 and a lower ITO conductive coating 118 facing toward the substrate layer.

The substrate layer 102 includes a glass substrate sheet 120 with an ITO conductive coating 122 that faces the switch layer 104. The substrate layer 102 also includes a silver linearity pattern 124 extending around the ITO coating 122 near the sides 106, 108, 110 and 112. The silver linearity pattern 124 is in turn covered by a dielectric protective layer 126. The silver linearity pattern 124 in this example is a conductive array of traces that act like a chain of resistors that interconnect corner electrodes (not shown) on a conventional five wire sensor. The silver linearity pattern 124 may help ensure that when touching close to the edge of the sensor, the touch sensed by the sensor does not wander in towards the center of the sensor such as in a pincushion pattern. The resistor chain formed by the silver linearity pattern 124 may compensate for the anomaly. This type of silver linearity pattern 124 may not be used for a conventional four wire sensor. Other conductive, low ohm materials such as metals, conductive inks or other coatings may also be used for a linearity pattern rather than silver.

Spacer dots 128 are provided on the substrate layer 102 to maintain an air gap 130 between the substrate layer 102 and the switch layer 104. A narrow gasket 132 seals the gap 130 around its periphery (i.e. at the sides 106, 108, 110 and 112).

The arrangement and specific materials and components of the touch sensor 100 in FIG. 1 is provided as an example only, and embodiments described herein are not limited to the particular type of touch sensor shown in FIG. 1, Other touch sensors having a gap filled with gas (such as air) may include still other layer components not shown in FIG. 1 and/or may omit components shown in FIG. 1. For example, in other embodiments, a metal mesh, organic coatings, carbon nano tubes, silver nano wire, rather than ITO may be sued for a conductive/resistive component of either the switch or substrate layer. As another example, the silver linearity pattern 124 and/or other components may be omitted.

Substrate and switch layers (such as the substrate and switch layers 104 and 102 described above) may be referred to as sheets herein, where it is to be understood that the substrate and switch sheets may include conductive layers that face each other.

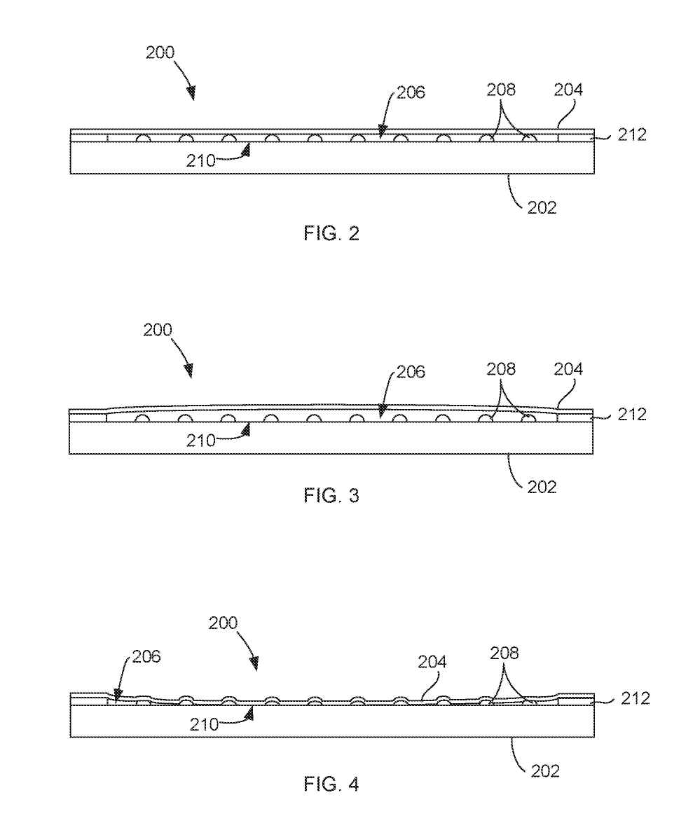

FIGS. 2 to 4 are each a side cross section view of a conventional touch sensor device 200. The touch sensor device 200 includes a substrate sheet 202 and a switch sheet 204 that overlays the substrate sheet 202. The substrate sheet 202 and the switch sheet 204 are spaced apart to form an air gap 206 between the substrate sheet 202 and the switch sheet 204. The substrate sheet 202 and the switch sheet 204 may be similarly sized and shaped (e.g. rectangular shaped) for a touchscreen. Spacer dots 208 between an upper surface 210 of the substrate sheet 202 and the switch sheet 204 help maintain the air gap 206. The switch sheet 204 is flexible such that, when touched, it deforms and contacts the substrate sheet 202 in the touched location. A gasket 212 forms a seal around the periphery of the gap 206 (i.e. around the perimeter of the sheets). The touch sensor may also include sensors (not shown) for detecting and determining a location of contact between the substrate and switch sheets 202 and 204 due to a touch.

FIG. 2 shows the touch sensor 200 in a normal state with regular pressure and volume of the air in the air gap 206.

FIG. 3 shows the touch sensor 200 in a pillowed state that may be caused by an increase in temperature or a decrease in pressure in the surrounding environment. For example, if the touch sensor 200 is shipped by air, the air pressure in a cargo hold of the airplane may be substantially less than at ground level causing the expansion of air in the gap 206 and the pillowed state shown in FIG. 3. If the air pressure in the gap 206 increases too much, the seal provided by the gasket 212 may temporarily or permanently rupture allowing air to escape from the gap,

FIG. 4 shows the touch sensor 200 in a collapsed state. In the air shipping example above, the seal may close when the touch sensor 200 is again at ground level, but with less air pressure in the gap 206 causing the collapsed state shown in FIG. 4. Alternatively, if the touch sensor is taken to a high pressure or low temperature environment, the air may compress or contract sufficiently that the touch sensor 200 collapses as shown. In the collapsed position, the switch sheet 204 may contact the substrate sheet 202 in one or more locations in the absence of any touch, thereby making touch detection difficult or impossible.

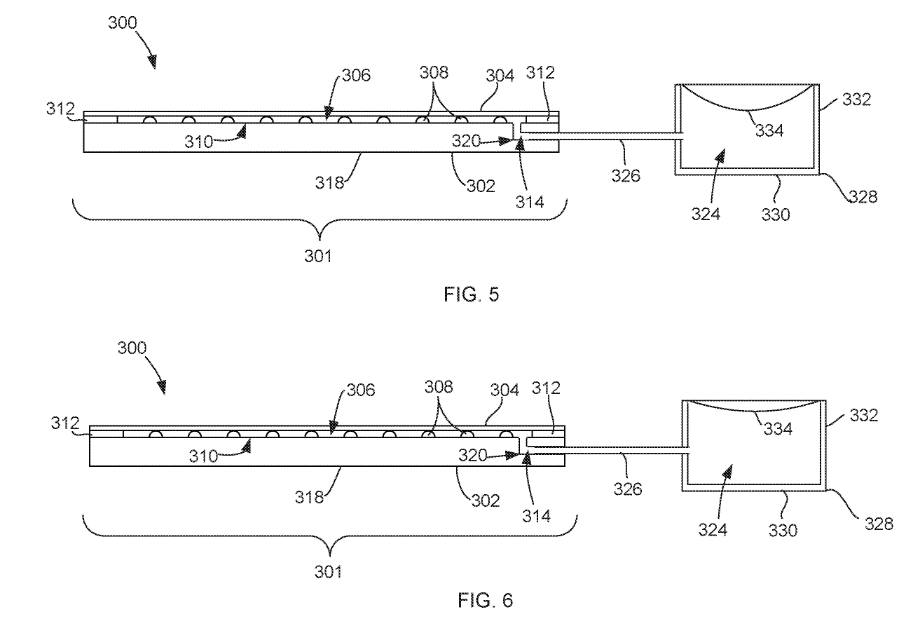

FIGS. 5 to 7 are each a side cross sectional view of a touch sensor device 300 according to one embodiment. The touch sensor device 300 in FIG. 3 includes a touch sensor 301 including a substrate sheet 302; a switch sheet 304 that overlays and is spaced from the substrate sheet 304 thereby forming an air gap 306; spacer dots 308 between the substrate sheet 302 and the switch sheet 304; and a gasket 312 sealing the outer edges/periphery of the gap 306, which are all arranged similar to the touch sensor 200 shown in FIG. 2. The substrate sheet 302 includes a first surface 310 that faces the gap 306 and the switch sheet 304. The first surface 310 is a front or upper surface in FIGS. 5 to 7, although the orientation of the touch sensor device 300 is not limited to that shown in these figures. The substrate sheet 302 and the switch sheet each include a conductive coating (not shown), such as ITO in this example, although other conductive surfaces (such as metal mesh) may be provided in other embodiments. For example, the conductive coating on the substrate sheet 302 will be provided on the first surface 310. Embodiments are also not limited to any particular material for the substrate and switch sheets 302 and 304. The substrate and switch sheets 302 and 304 may be transparent (e.g. glass) for use in a touchscreen panel, for example.

The touch sensor device 300 further includes a hole 314, that functions as a port, in the substrate sheet 302. The hole 314 that extends from the air gap 306 (at the first surface 310) to the side surface 316 of the substrate sheet 302. In other embodiments, the hole 314 may extend to a different outer surface (such as a different side, or to the back/IoN,ver surface 318 that is opposite to the first surface 310). The hole 314 includes a 90 degree bend 320 such that the hole extends downward from the first surface 310 and then turns to the side surface 318. However, the arrangement, shape, width and length of the hole may vary in other embodiments. Any hole, port or aperture that extends between an outer surface and the air gap 306 may be used.

The touch sensor device 300 further includes a regulator device 322. The regulator device 322 defines a chamber 324 that is filled with air. The touch sensor device 300 also includes a tube 326 connected between the chamber 324 and the hole 314 in the substrate sheet 302 such that air can flow between the chamber 326 and the air gap 306 between the substrate sheet 302 and the switch sheet 304, The chamber 324 in this example is formed by a generally cylindrical chamber housing 328 including chamber bottom 330 and circular chamber periphery 332. The chamber housing may be in another shape, such as a box shape, in other embodiments. A diaphragm 334 forms an upper wall or top of the chamber housing 328. The diaphragm 334 in this example is a flexible elastomeric film, such as latex. Other flexible materials, such as low durometer materials, that are gas impermeable (and possibly hydrogen impermeable) may also be used. The thickness of the diaphragm may vary. For a latex film diameter, the film thickness may be 0.1 mm, for example. The diaphragm 334 is flexible to allow expansion and contraction of the chamber 324. The diaphragm housing 328 may be made of any air-impermeable material including but not limited to hard plastic or rubber,

Any embodiment similar in operation to the diaphragm-type regulator device 322 described herein may be used. For instance, a bag that has sufficient surface rigidity or other spring device assistance that allows it to resist inflation or deflation may be used. Also, a bellows or accordion type device that resists inflation or deflation may also be used.

The tube 326 may be connected in a sealed manner to the hole 314 and to the regulator device 322. The assembled touch sensor device 300 may be hermetically sealed. The tube may be a catheter made plastic or any other suitable impermeable material. The catheter may be approximately 1mm in diameter, for example but any suitable size of tubing that allows sufficient air movement can be used. Any method for securing the tube 326 between the hole 314 and the regulator device 322 may be used including, but not limited to, sealants and/or adhesives, gasket(s), etc. The tube 326 may also be melted or welded to form the sealing attachment to the hole 314 and/or the regulator device 322. As another example, the tube 326 may be formed integrally with the chamber housing 328, The tube 326 may be made of any air-impermeable material including but not limited to plastic or rubber. In still other embodiments, the tube 326 may be omitted and other means of connecting the regulator device 322 to the touch sensor 301 may be used. For example, other conduits such as a pipe, or extension from the substrate sheet may extend into an inlet in the regulator device. Any suitable means to provide the air flow connection to the chamber from the air gap may be used.

The diaphragm 334 may be more flexible than the switch sheet 304, such that the volume of the chamber 324, rather than the air gap 306, changes in response to changes in temperature and pressure of the surrounding environment. Thus, when the air in the touch sensor device 300 expands, excess air may be vented from the air gap 306 to the chamber 324 of the regulator device 32. The chamber 324 expands due to the flexibility of the diaphragm 334. Similarly, if air within the touch sensor device 300 contracts, air may flow from the chamber 324 of the regulator device 322 to the air gap 306.

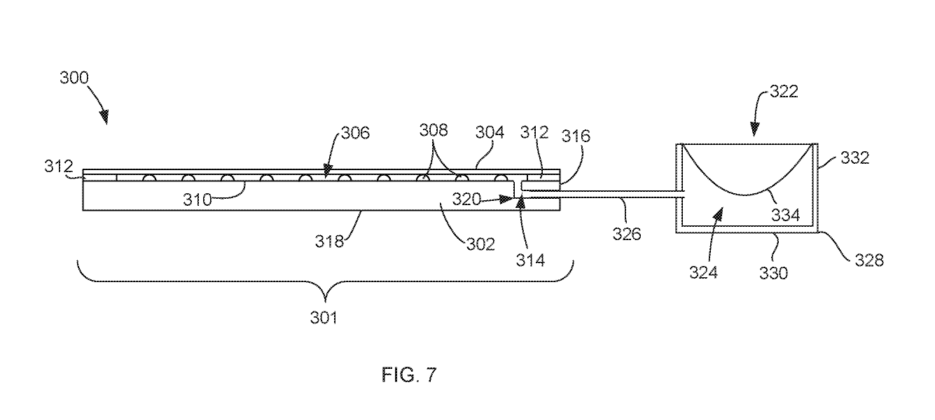

FIG. 5 shows the touch sensor device 300 in a first state, which may be a normal state at ground level at room temperature, for example. The air pressure in the touch sensor device 300 may be regulated by regulator device 322 to more closely match the external pressure, and thus, the regulator device 322 may decrease the likelihood of seal damage and/or collapse of the touch sensor 301, as shown in FIGS. 6 and 7.

FIG. 6 shows the touch sensor device 300 in a second state, where air in the touch sensor device 300 has expanded due to increased temperature and/or decreased external pressure. As shown, the chamber 324 of the regulator device 322 has expanded by movement of the diaphragm 334, and the switch sheet 304 is not substantially pillowed. Instead, the switch sheet 304 is substantially in the same position as in FIG. 5, and the change of the volume of air is managed by the regulator device 322. Thus, the pressure in the air gap 306 is regulated and may be less likely to damage or breach the seal formed by the gasket 312,

FIG. 7 shown the touch sensor device 300 in a third state, where air in the touch sensor device 300 has contracted due to decreased temperature and/or increased external pressure. As shown, the chamber 324 of the regulator device 322 has contracted by movement of the diaphragm 334, and the switch sheet 304 is substantially in the same position (with the change in air volume managed by the regulator device 322). Thus, the pressure in the air gap 306 is regulated and may be less likely to collapse the touch sensor 301. The amount of expansion and contraction shown in FIGS. 5 to 7 is by way of example only, and the actual amount of expansion and contraction may vary.

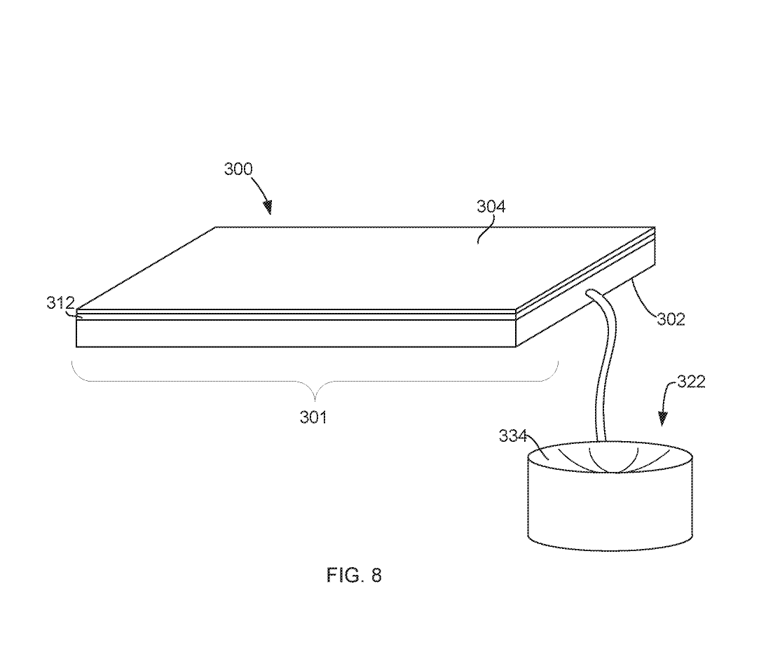

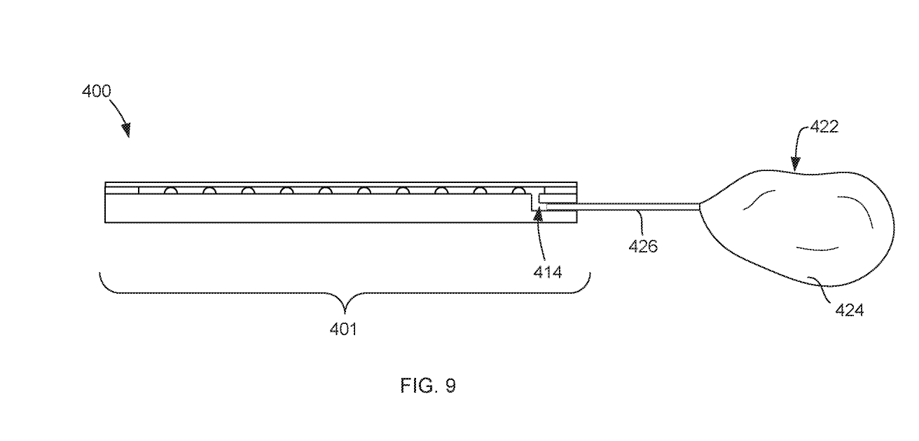

FIG. 8 is a perspective view of the touch sensor device 300 shown in FIGS. 5 to 7, showing the general shape of the substrate and switch sheets 302 and 304, the gasket 312, and the regulator device 322 including the diaphragm 334. A person skilled in the art will appreciate that the size, thickness and shape of the touch sensor 301, including the substrate and switch sheets 302 and 304, may vary. Typically, the substrate and switch sheets 302 and 304 and gasket 312 will be much thinner than shown in FIG. 8. The regulator device 322 may also vary in size, shape, and volume of the chamber 324 (shown in FIGS. 5 to 7). For example, the volume may depend on the size of the touch screen sensor 301, the expected environment and changes in temperature or pressure, and the desired level of protection against damage.

The regulator device 322 shown in FIGS. 5 to 8 may include an inlet and/or outlet valve (not shown) for adding or removing air from the diaphragm. For example, a port for a hypodermic needle (not shown) may be included so that air may be added or removed from the diaphragm as needed to achieve the desired amount of air in the touch sensor device 300. Other means for adjusting the amount of air (or other gas mixture) in the device may also be used.

Embodiments are not limited to the diaphragm-type regulator device 322 shown in FIGS. 5 to 8. Any device comprising an expandable and contractible chamber suitable to regulate volume and pressure of the air in the touch sensor device may be used.

The size and volume of gas held by the chamber of a regulator device (such as regulator device 322 in FIGS. 5 to 8) may vary. For example, the volume may depend on the size of the resistive sensor for which the regulator device is used. The volume may also depend on the nature of the chamber as well (such as the elasticity of the diaphragm). In one embodiment, a diaphragm-type regulator device (similar to the regulator device 322 in FIGS. 5 to 8) may include an approximately 35cc chamber (at normal temperature/pressure) for a 15 inch resistive sensor panel. A similar sized regulator device may also be used with smaller sensors, for example. However, embodiments are not limited to any particular size of regulator device chamber.

FIG. 9 is a side cross sectional view of a touch sensor device 400 including a touch sensor 401 and a regulator device 422 according to another embodiment. The touch sensor 401 is similar to the touch sensor 301 in FIGS. 5 to 8. The regulator device 422 is again connected to the hole 414 in the touch sensor 401 via a tube 426 (although any suitable conduit and not necessarily a tube may be used). The regulator device in this embodiment is a bag or pouch 424 that is only partially full at normal operating pressure and temperature to allow expansion or contraction as needed. The bag 424 may be filled with sponge foam. The bag may be made of mylar or other suitable gas impermeable materials.

In some embodiments, the regulator device described herein (such as the regulator device 300 or 400 shown in FIGS. 5 to 9) may be provided separately from a touch sensor. For example, the regulator device may be provided separately and a conventional touch sensor having a gap between two or more sheets or layers may be modified for connection to the regulator device.

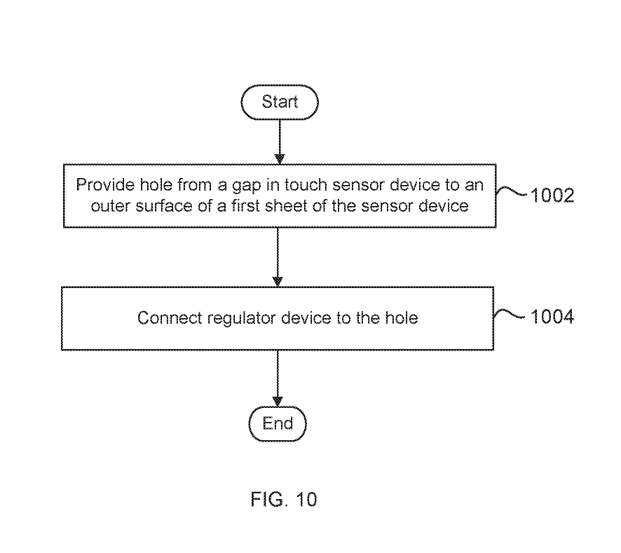

FIG. 10 is a flowchart of a method for regulating pressure in a touch sensor according to some embodiments. The touch sensor may be similar to the resistive touch sensors described herein (including touch sensors 301 and 401 shown in FIGS. 5 to 9) that have a gas-filed gap between first and second sheets. The gap may be sealed as described above. The gas may be air, as in the examples shown in FIGS. 5 to 9. At block 1002, a hole is provided in the first sheet from the gap to an outer surface of the first sheet. At block 1004, a regulator device is connected to the hole. The regulator device includes an expandable and contractible chamber (connected to the hole) to allow flow of the gas between the chamber and the gap and may be similar to any regulator device described above (such as the regulator device 322 or 422 shown in FIGS. 5 to 9). The connecting step at block 1004 may include connecting a tube between the hole and the regulator device (such as the tube 326 or 426 shown in FIGS. 5 to 9).

It is to be understood that a combination of more than one of the approaches described above may be implemented. Embodiments are not limited to any particular one or more of the approaches, methods or apparatuses disclosed herein. One skilled in the art will appreciate that variations, alterations of the embodiments described herein may be made in various implementations without departing from the scope of the claims.

1. A touch sensor device comprising:
a first sheet having a first conductive layer;
a second sheet having a second conductive layer overlaying and spaced from the first conductive layer of the first sheet, thereby forming a gap between the first and second sheets, the gap being filled with gas and having a sealed periphery;
a hole in the first sheet extending from the gap to an outer surface of the first sheet; and
a regulator device comprising an expandable and contractible chamber, the regulator device being connected to the hole to allow flow of the gas between the chamber and the gap.

2. The touch sensor device of claim 1, further comprising a conduit connecting the regulator device is connected to the hole allowing said flow of the gas.

3. The touch sensor device of claim 1, wherein the chamber expands and contracts to regulate pressure of the gas in the gap.

4. The touch sensor device of claim 3, wherein the chamber comprises a flexible diaphragm that provides said expansion and contraction.

5. The touch sensor device of claim 4, wherein the diaphragm comprises an elastomeric film.

6. The touch sensor device of claim 5, wherein the elastomeric film comprises latex.

7. The touch sensor device of claim 1, wherein the hole extends through the first conductive layer and to the outer surface.

8. The touch sensor device of claim 7_{;} wherein the outer surface of the first sheet is a side surface between the first surface and a back surface opposite to the first surface.

9. The touch sensor device of claim 7, wherein the outer surface of the first sheet comprises a back surface opposite to the first surface.

10. The touch sensor device of claim 1, wherein the first sheet comprises a substrate sheet and the first sheet comprises a switch sheet.

11. The touch sensor device of claim 10, wherein the second sheet is flexible to contact the first sheet when touched.

12. The touch sensor device of claim 10, wherein the substrate sheet and the switch sheet are each substantially transparent.

13. The touch sensor device of claim 1, wherein each of the first and second sheets comprise a conductive coating.

14. The touch sensor device of claim 13, wherein the device is hermetically sealed.

15. The touch sensor device of claim 1, wherein the gas comprises air.

16. A method for a resistive touch sensor comprising a first sheet overlaying and spaced from a second sheet to form a gap therebetween filled with gas, the method comprising:
providing a hole in the first sheet from the gap to an outer surface of the first sheet;
connecting a regulator device comprising an expandable and contractible chamber to the hole to allow flow of the gas between the chamber and the gap.

17. The method of claim 16, wherein said connecting comprises connecting a tube between the hole and the regulator device.

18. A regulator device for a touch sensor comprising a first sheet overlaying and spaced from a second sheet to form a gap therebetween filled with gas, the regulator device comprising:
an expandable and contractible chamber;
a conduit for connecting the regulator device to a hole in the touch sensor to allow flow of the gas between the chamber and the gap.

19. The regulator device of claim 18, wherein the conduit comprises a tube.

20. The regulator device of claim 18, wherein the chamber expands and contracts to relieve regulate at least one of pressure and volume of the gas in the gap.

21. The regulator device of claim 20, wherein the chamber comprises a flexible diaphragm that provides said expansion and contraction.

22. The regulator device of claim 21, wherein the diaphragm comprises an elastomeric film.

23. The regulator device of claim 22, wherein the elastomeric film comprises latex.
